(19) United States
(12) Patent Application Publication
(10) Pub. No.: US 2002/0036639 A1
(43) Pub. Date: Mar. 28, 2002

(54) Textual format for animation in multimedia systems

(76) Inventor: Mikael Bourges-Sevenier, Santa Clara, CA (US)

Correspondence Address: Ronald L. Yin, GRAY CARY WARE & FREIDENRICH LLP, 1755 Embarcadero Road, Palo Alto, CA, 94303-3340, US

(21) Appl. No.: 09/772,446

(22) Filed: Jan. 29, 2001

Related U.S. Application Data
(60) Provisional application No. 60/179,220, filed on Jan. 31, 2000.
(60) Provisional application No. 60/179,229, filed on Jan. 31, 2000.

(51) Int. Cl. G06T 13/00

(52) U.S. Cl. 345/474

(57) ABSTRACT

An apparatus and method of processing an animation. An animation path is identified and segmented into at least one section. For each section of the animation path a non-linear parametric representation is determined to represent each section of the animation path. The non-linear representation is represented, or coded, in a virtual reality scene descriptive language. The scene descriptive language, containing the non-linear representation may be processed by receiving an initial scene description. Then specifying changes in the scene from the initial scene. Interpolating scenes between the initial value, and the changes from the initial value, by a non-linear interpolation process. The non-linear interpolation process may be performed by a non-linear interpolator in the scene descriptive language. Scenes may also be deformed by defining a sub-scene, of the scene, in a child node of the scene descriptive language. After the sub-scene has been defined control points within the sub-scene are moved to a desired location. The sub-scene is then deformed in accordance with the movement of the control points of the sub-scene.

### REFERENCE TO PRIORITY DOCUMENT

This application claims the benefit of U.S. Provisional Application No. 60/179,220, filed on Jan. 31, 2000.

### BACKGROUND OF THE INVENTION

1. Field of the Invention

This invention relates to the field of animation of computer generated scenes. More particularly, the invention relates to generating animation paths in virtual reality scene descriptive languages.

2. Description of the Related Art

Graphic artists, illustrators, and other multimedia content providers have been using computer graphics and audio techniques to provide computer users with increasingly refined presentations. A typical multimedia presentation combines both graphic and audio information. Recently, content providers have increased the amount of three-dimensional (3D) graphics and multimedia works within the content provided. In addition, animation is increasingly being added to such presentations and multimedia works content.

3D graphics and multimedia works are typically represented in a virtual reality scene descriptive language. Generally, virtual reality scene descriptive languages, such as Virtual Reality Modeling Language (VRML), describe a scene using a scene graph model. In a scene graph data structure the scene is described in text, along with the objects contained within the scene and the characteristics of each object such as shape, size, color and position in the scene. Scene graphs are made up of programming elements called nodes. Nodes contain code that represents objects, or characteristics of an object, within a scene. There are two types of nodes: parent nodes; and children nodes. Parent nodes define characteristics that affect the children nodes beneath them. Children nodes define characteristics of the object described in the node. Nodes may be nested, with a node being a child to its parent and also being a parent to its children.

In addition to describing static scenes, scene descriptive languages may also provide for changes to an object in the scene. For example, an object within a scene may begin at an initial position and then travel along a desired path to an ending position, or an object may be an initial color and change to a different color.

Communicating successive scenes from one network location to another for animation in a scene description language may be accomplished in several different ways including, streaming and interpolation. In a streaming animation a remote site establishes a connection with a server. The server calculates successive scenes that contain the animation. The server transmits the successive animation scenes to the remote unit for display. The scenes may be displayed as they arrive or they may be stored for later display. In another method of streaming, the server sends updates, for example, only the difference between consecutive scenes and the remote unit updates the display according to these differences.

Interpolation is performed by the remote unit. An initial setting and an ending setting of an animation is established. An interpolator then calculates an intermediate position, between the initial and ending positions, and updates the display accordingly. For example, in VRML, interpolator nodes are designed to perform a linear interpolation between two known “key” values. A time sensor node is typically used with interpolators, providing start time, stop time and frequency of update. For example, the interpolation of movement of an object between two points in a scene would include defining linear translations wherein updates are uniformly dispersed between start time and stop time using linear interpolation.

Linear interpolators are very efficient. They do not require a significant amount of processing power, and can be performed very quickly. Thus, linear interpolators are efficient for client side operations to give the appearance of smooth animation. A drawback to linear interpolators is that to reproduce complex movement in an animation requires many “key” values to be sent to the interpolator.

FIG. 1 is a graph illustrating a linear interpolation of a semi-circle. In FIG. 1 there is a horizontal axis representing the “keys” and a vertical axis representing the key_value. A desired motion, from “key” equal to 0, to “key” equal to 1, is represented by a semi-circle 102. Reproduction of the semi-circle with a linear interpolator function, using three (3) “key” values, is shown as trace 104. For this example, the interpolator “keys” correspond to values of 0, 0.5, and 1 with respective key_value of 0, 0.5, and 0. Inspection of trace 104 shows that it is a coarse reproduction of the semi-circle with significant errors between the interpolated trace 104 and the desired trace 102.

To improve the reproduction of the desired trace, and decrease the errors between the two traces, additional “key” values can be added to the interpolator. For example, if five (5) “key” values are used then the dashed line trace 106 is produced. In this example, the “keys” correspond to values of 0, 0.25, 0.5, 0.75, and 1 with respective values of 0, 0.35, 0.5, 0.35, and 0. Inspection of trace 106 shows that it is a better reproduction of the semi-circle than trace 104, with less error between the interpolated trace and the desired trace. However, the improvement in representing the semi-circle requires specifying additional “key” values for the interpolator, which adds complexity. In addition, if the interpolator “key” values are being transmitted to a remote unit from a server there is an increase in the required bandwidth to support the transmission. Furthermore, even by increasing the number of “key” values there will still be errors between the desired trace and the reproduced trace.

The interpolation techniques described above are not satisfactory for applications with animations that include complex motion. Therefore, there is a need to more efficiently reproduce complex animation. In addition, the reproduction of the complex animation should not significantly increase the bandwidth requirements between a server and a remote unit.

### SUMMARY OF THE INVENTION

An animation path is identified and segmented into at least one section. A non-linear parametric representation is determined to represent each section of the animation path. The non-linear representation is represented, or coded, in a virtual reality scene descriptive language. A virtual reality scene descriptive language containing animation is processed by receiving an initial scene description and specifying changes from the initial scene. Scenes between the initial value, and the changes from the initial value, are interpolated by a non-linear interpolation process. The non-linear interpolation process may be performed by a non-linear interpolation engine in the scene descriptive language in accordance with control parameters relating to an animation path in a scene description, and a timing signal input. Using the control and timing inputs the interpolation engine may reproduce a non-linear animation path, and to output a new animation value for use in the scene description.

Deforming a scene is described in a scene descriptive language by defining a sub-scene, of the scene, in a child node of the scene descriptive language. After the sub-scene has been defined control points within the sub-scene are moved to a desired location. The sub-scene is then deformed in accordance with the movement of the control points of the sub-scene.

### BRIEF DESCRIPTION OF THE DRAWINGS

FIG. 1 is a graph illustrating a linear interpolation of a semi-circle.

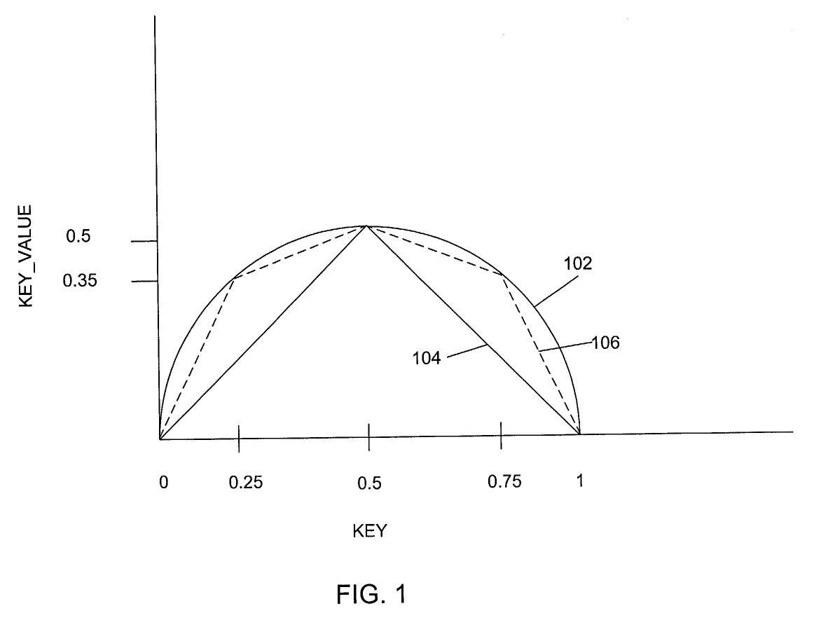

FIG. 2 is a scene graph of a scene descriptive language illustrating the hierarchical data structure.

FIG. 3 is a block diagram illustrating the decoding of a scene descriptive language data file.

FIG. 4 is a block diagram illustrating an interpolator and time sensor node in VRML.

FIG. 5 is a diagram illustrating a complex movement of an object.

FIG. 6 is a graph illustrating the four (4) curves used in a cubic Bezier representation.

FIG. 7 is a chart illustrating three independent components of a value.

FIG. 8 is a chart illustrating three independent components of a value.

FIG. 9 is a block diagram of the BIFS-Anim encoding process.

FIG. 10 is a block diagram of an exemplary computer such as might be used to implement the CurveInterpolator and BIFS-Anim encoding.

### DETAILED DESCRIPTION

As discussed above, content developers generally use a text-based language to describe or model a scene for computer representation. One such text-based language is referred to as Virtual Reality Modeling Language (VRML). Another such text-based language is referred to as Extensible Markup Language (XML). Both the VRML and XML specifications may be found on the Internet at the “World Wide Web” URL of www.web3d.org/fs_specifications.htm. In addition, the Motion Picture Experts Group version 4(MPEG-4) is an international data standard that addresses the coded representation of both natural and synthetic (i.e., computer-generated) graphics, audio and visual objects. The MPEG-4 standard includes a scene description language similar to VRML and also specifies a coded, streamable representation for audio-visual objects. MPEG-4 also includes a specification for animation, or time variant data, of a scene. The MPEG-4 specification can be found on the Internet at the MPEG Web site home page at the “World Wide Web” URL of www.cslet.it/mpeg/.

A text-based scene description language provides the content developer with a method of modeling a scene that is easily understood, in contrast to machine readable data used by computer hardware to render the display. Typically, a text-based scene descriptive language will list the data parameters associated with a particular object, or group of objects, in a common location of the scene. Generally, these data parameters may be represented as “nodes.” Nodes are self-contained bodies of code containing the data parameters that describe the state and behavior of a display object, i.e., how an object looks and acts.

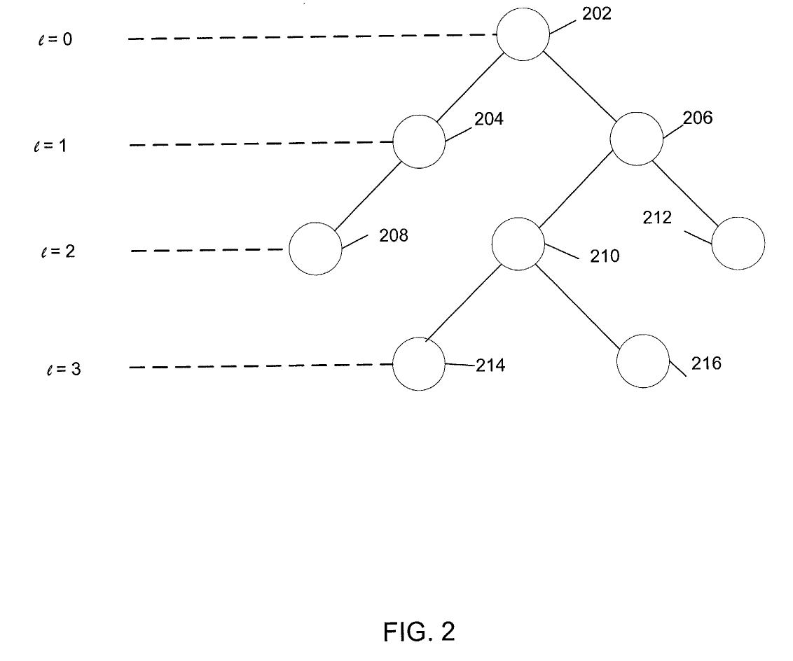

Nodes are typically organized in a tree-like hierarchical data structure commonly called a scene graph. FIG. 2 is a scene graph of a scene descriptive language illustrating the hierarchical data structure. The scene graph illustrated in FIG. 2 is a node hierarchy that has a top “grouping” or “parent” node 202. All other nodes are descendents of the top grouping node 202 in level 1. The grouping node is defined as level 0 in the hierarchy. In the simple scene graph illustrated in FIG. 2, there are two “children” nodes 204 and 206 below the top parent node 202. A particular node can be both a parent node and a child node. A particular node will be a parent node to the nodes below it in the hierarchy, and will be a child node to the nodes above it in the hierarchy. As shown in FIG. 2, the node 204 is a child to the parent node 202 above it, and is a parent node to the child node 208 below it. Similarly, the node 206 is a child node to the parent node 202 above it, and is a parent node to the child nodes 210 and 212 below it. Nodes 208, 210, and 212 are all at the same level, referred to as level 2, in the hierarchical data structure. Finally, node 210, which is a child to the parent node 206, is a parent node to the child nodes 214 and 216 at level 3.

FIG. 2 is a very simple scene graph that illustrates the relationship between parent and child nodes. A typical scene graph may contain hundreds, thousands, or more nodes. In many text-based scene descriptive languages, a parent node will be associated with various parameters that will also affect the children of that parent node, unless the parent node parameters are overridden by substitute parameters that are set at the child nodes. For example, if the parameter that defines the “3D origin” value of the parent node 206 is translated along the X-axis by two (2) units, then all objects contained in the children of the node 206 (nodes 210, 212, 214, and 216) will also have their origin translated along the X-axis by two (2) units. If it is not desired to render an object contained in the node 214 so it is translated to this new origin, then the node 214 may be altered to contain a new set of parameters that establishes the origin for the node 214 at a different location.

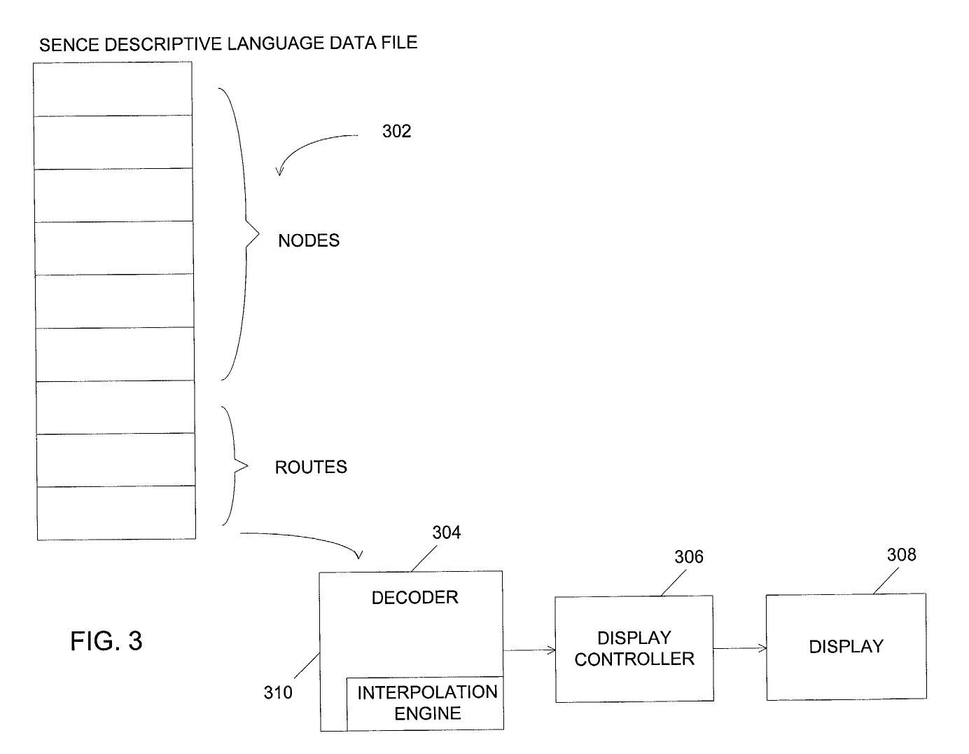

FIG. 3 is a block diagram illustrating the decoding of a scene descriptive language data file. In FIG. 3, a scene descriptive language data file 302 includes nodes and routes. As described above, nodes describe the scene, objects within the scene, and the characteristics of the objects. For example, nodes include object shape, object color, object size, interpolator nodes, and time sensor nodes. In addition to nodes, the scene descriptive language data file 302 includes routes. Routes associate an “eventOut” field of one node to an “eventIn” field of another node. An “eventOut” field of a node outputs a value when a particular event occurs, for example, a mouse movement or a mouse click. The value output by a first node as an “eventOut” field can be received by a second node as an “eventin” field.

The scene descriptive language data file 302 is processed by a decoder 304. The decoder receives the scene descriptive language data file 302 and processes the nodes and routes within the data file. The decoder 304 outputs scene information, decoded from the data file, to a display controller 306. The display controller receives the scene information from the decoder 304 and outputs a signal to control a display 308 which provides a visual display of the scene corresponding to the data file 302.

In one embodiment, the decoder 304 may also include an interpolation engine 310. The interpolation engine receives data from interpolator node fields and determines intermediate values for a desired field. For example, in VRML the interpolation engine is a linear interpolation engine that determines updates to the value of a desired field with uniformly between start and stop points. Interpolator nodes, time sensor nodes, and interpolation engines support animation in a scene descriptive language such as VRML or MPEG-4.

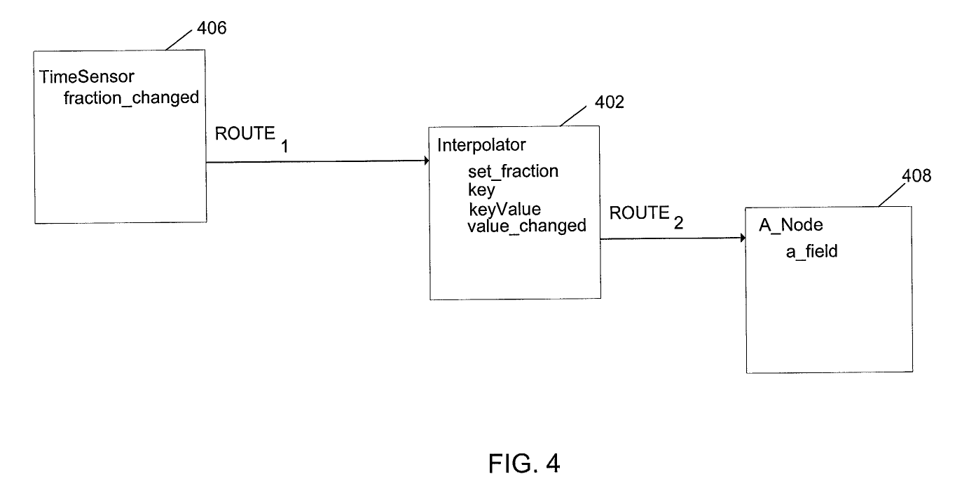

FIG. 4 is a block diagram illustrating an interpolator type of node and a time sensor type of node in a scene descriptive language such as VRML or MPEG-4. As shown in FIG. 4, generally an interpolator node 402 is associated with a time sensor node 406 using routes. The time sensor node 406 provides start time, stop time, and speed of animation. The interpolator node 402 includes four (4) data fields: set_fraction; key; key_value; and value_changed. Data field set_fraction is an eventIn field, and data field value_changed is an eventOut field. Data fields key and key_value are exposed fields. An exposed field is a data field in a node that may have its value changed, for example, by another node. As discussed below, in an interpolator node 402 the exposed fields, key and key_value, are used to define an animation path.

The time sensor node 406 includes an eventOut data field called fraction-changed. Time sensor node 406 outputs a value for fraction-changed, having a value between 0 and 1 corresponding to the fractional amount of time, of a period specified to correspond to the animation time. The time sensor node 406 output, event fraction_changed, is routed to the interpolator 402 input event set_fraction. An interpolator engine, using the set_fraction event in, and the key and key_value performs an interpolation. For example, in VRML and MPEG-4, the interpolation engine performs a linear interpolation. The interpolated value, value_changed, is routed to A_Node 408, where a_field, representing a characteristic of the scene, for example, an object's color, location, or size, is modified to reflect the animation.

As discussed above, for complex animation paths linear interpolators require a high band width to transfer all the key and key_value data from a server to a remote unit. To overcome this, as well as other drawbacks associated with linear interpolators non-linear interpolators may be used. In a scene descriptive language, such as VRML or MPEG-4, non-linear interpolators, or curve interpolators, may be used to provide an improved animation path for characteristics of an object in a scene. For example, characteristics of an object in a scene may be changed in a non-linear manner such as, using a scalar curve interpolator to change the apparent reflectivity or transparency of a material, or using a color curve interpolator to change the color of an object. In addition, examples of defining the location of an object in a scene may be changed in a non-linear manner may include using a position curve interpolator to define an objects location in 3D coordinate space, or using a position 2D curve interpolator to define an object's location in 2D coordinate space.

CurveInterpolators

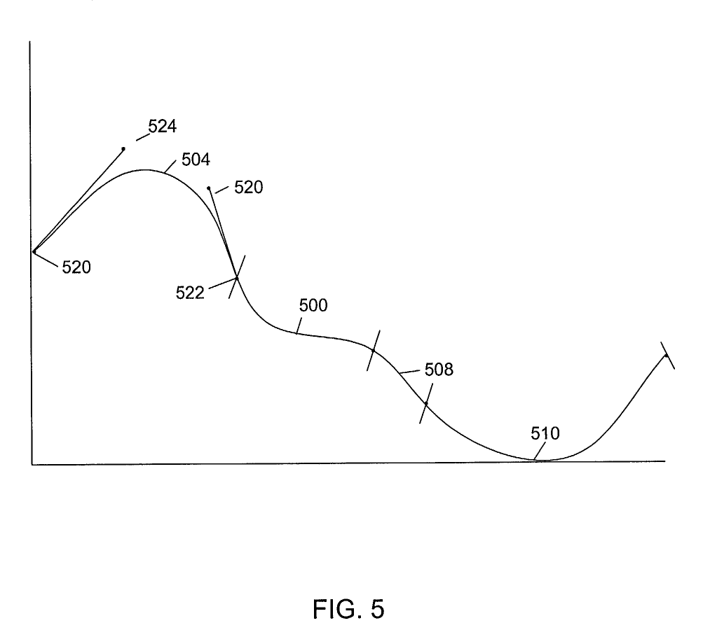

FIG. 5 is a diagram illustrating a complex movement of an object along a path 502, for example an animation path. To specify the movement along the animation path 502, the animation path 502 is segmented into sections. For example, the animation path 502 may be segmented into four (4) sections, 504, 506, 508, and 510. Each section of the animation path 502 may then be defined by a non-linear, parametric representation. In one embodiment, the non-linear parametric representation may be any non-uniform rational B-spline. For example, the non-linear representation may be a Bezier curve, a B-spline, a quadratic, or other type of non-linear representation.

In a Bezier representation, each path segment 504, 506, 508, and 510 may be represented by data values, or control points. The control points include the end points of the section of the animation path being represented and two (2) additional control points that do not coincide with the section of the animation path being represented. The location of the control points influences the shape of the representation for reproducing the animation path section. Using a cubic Bezier representation of the animation path illustrated in FIG. 5, the animation path can be specified by sixteen (16) control points corresponding to key_value. As discussed above, to specify the animation path 502 using linear interpolators, depending on the quality of reproduction desired, would require using significantly more than sixteen (16) key_value.

A Bezier representation, or spline, is a mathematical construct of curves and curved surfaces. In a Bezier representation, at least one or more curves are combined to produce the desired curve. The most frequently used Bezier curve for two-dimensional graphic systems is a cubic Bezier curve. As discussed above, a cubic Bezier may define a curved section of an animation path using four (4) control points. Although cubic Bezier curves are most frequently used for two-dimensional graphic systems, different order Bezier curves may be used to create highly complex curves in two, three or higher dimensions.

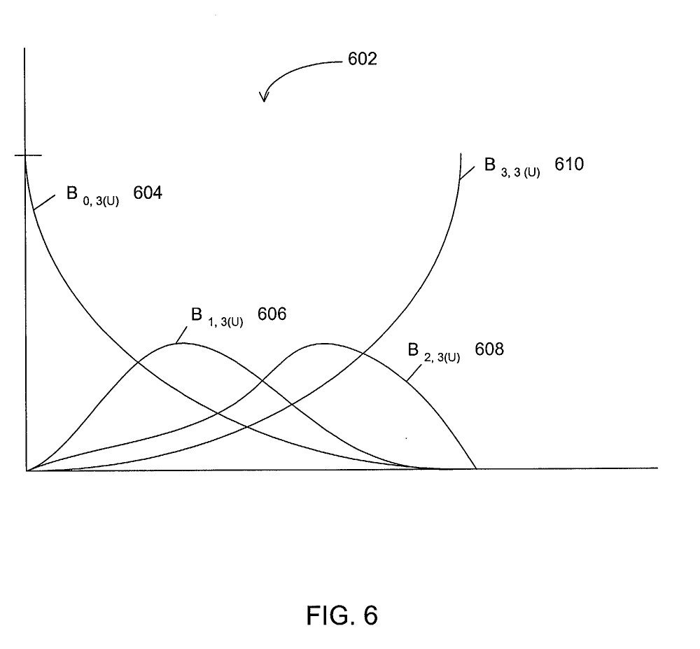

FIG. 6 is a graph illustrating the four (4) curves used in a cubic Bezier representation 602. The basic cubic Bezier curve Q(u) is defined as.

$$Q ( u ) = {\sum }_{i = 0}^{3} {p}_{i} {B}_{i , 3} ( u )$$

The four (4) curves making up the cubic Bezier representation are referred to as B_{0,3}(u) 604, B_{1,3}(u) 606, B_{2,3}(u) 606, and B_{3,3}(u) 610. These four curves are defined as

B_{0,3}(u)=(1−u)³=−u³+3u²−3u+1

B_{1,3}(u)=3u(1−u)²=3u³−6u²+3u

B_{2,3}(u)=3u²(1−u)=3u³+3u²

B_{3,3}(u)=u³

Expressing the cubic Bezier curve Q(u) as a matrix defined by the four (4) curves and the four control points consisting of the two end points of the animation path Pᵢ and Pᵢ₊₃ and the two off-curve control points, or tangents, Pᵢ₊₁ and P_{i+2:}

$$Q ( u ) = [ \begin{matrix}{u}^{3} & {u}^{2} & u & 1\end{matrix} ] [ \begin{matrix}- 1 & 3 & - 3 & 1 \\ 3 & - 6 & 3 & 1 \\ - 3 & 3 & 0 & 0 \\ 1 & 0 & 0 & 0\end{matrix} ] [ \begin{matrix}{P}_{i} \\ {P}_{i + 1} \\ {P}_{i + 2} \\ {P}_{i + 3}\end{matrix} ]$$

For a curve, or animation path, specified by a non-linear interpolator, such as a cubic Bezier curve, the parameter (t) in the set_fraction data field of the time sensor node 406 is modified. The parameter (t) is converted from a value of 0 to 1 to the i^{th} curve parameter (u) defined as:

$$u = \frac{t - {k}_{i}}{{k}_{i + 1} - {k}_{i}}$$

If an animation path is made up of n curve sections, then there are l=3n+1 control points in key_value for n+1 keys. The format to specify the control points is:

$$\underbrace{{P}_{0} {P}_{1} {P}_{2} {P}_{3}}_{{C}_{0}} … \underbrace{{P}_{3 , i} {P}_{3 , i + 1} {P}_{3 , i + 2} {P}_{3 , i + 3}}_{{C}_{i}} … \underbrace{{P}_{3 , n - 3} {P}_{3 , n - 2} {P}_{3 , n - 1} {P}_{3 , n}}_{{C}_{n - 1}}$$

The syntax of the node is as follows: C₀ is defined by control points P₀ to P₃; C₁ is defined by control points P₃ to P₆; Cᵢ is defined by control points P₃ᵢ to P₃ᵢ₊₃; and Cₙ₋₁ is defined by control points P₃ₙ₋₃ to P₃ₙ.

To use cubic Bezier curves to construct an arbitrary curve, such as curve 502 of FIG. 5, the curve is segmented into a number of individual sections. This is illustrated in FIG. 5 where the curve 502 is divided into four sections. A section 504 of the curve extends between end points 520 and 522. End points of the section 504 correspond to control points Pᵢ and Pᵢ₊₃ in the discussion above. Control points 524 and 526 correspond to control points Pᵢ₊₁ and Pᵢ₊₂ in the discussion above. Using a cubic Bezier curve and the four control points, the section 504 of the animation path 502 can be generated using a well known reiterative process. This process is repeated for sections 506, 508 and 510 of the animation path 502. Thus, the animation path 502 can be defined by thirteen Bezier control points. In a similar manner, almost any desired curved animation path can be generated from a set of selected control points using the Bezier curve technique.

Various types of virtual reality scene description interpolators can be provided as non-linear interpolators. For example, in VRML or MPEG-4, non-linear interpolators can include ScalarCurveInterpolator, ColorCurveInterpolator, PositionCurveInterpolator, and Position2DcurveInterpolator to provide non-linear interpolation of objects, and their characteristics, in a scene.

ScalarCurveInterpolator

The simplest of the non-linear interpolators is the ScalarCurveInterpolator. The ScalarCurveInterpolator specifies four key_value fields for each key_field. The four key value fields correspond to the four control points that define the curve section of the animation path of the scalar value being interpolated. The syntax of the ScalarCurveInterpolator is shown below where the four data fields: set_fraction, key; key_value; and value_changed are data types: eventIn; exposedField; exposedField; and eventOut, respectively, and are represented by value types: single-value field floating point; multiple-value field floating point; multiple-value field floating point; and single-value field floating point, respectively.

ScalarCurveInterpolator {

| | | |
|---|---|---|
| eventIn | SFFloat | set_fraction |
| exposedField | MFFloat | key |
| exposedField | MFFloat | keyValue |
| eventOut | SFFloat | value_changed |

}

The ScalarCurveinterpolator can be used with any single floating point value exposed field. For example, the ScalarCurvelnterpolator and change the speed at which a movie, or sound, is played, or change the apparent reflectivity or transparency of a material in a scene display in a non-linear manner.

ColorCurveInterpolator

The ColorCurveInterpolator node receives a list of control points that correspond to a list of RGB values. The ColorCurveInterpolator will then vary the RGB values according to the curve defined by the respective control points and output an RGB value. The syntax for the ColorCurveInterpolator is similar to the ScalarCurveInterpolator except that data field value_changed is represented by a value type single-value field color. Also, the ColorCurveInterpolator includes two additional data fields: translation; and linked which are data types: exposedField; and exposedField, respectively, and are represented by value types: single-value field 2D vector; and single-value field Boolean, respectively

ColorCurveInterpolator {

| | | | |
|---|---|---|---|
| eventIn | SFFloat | set_fraction | |
| exposedField | MFFloat | key | |
| exposedField | MFColor | key Value | |
| eventOut | SFColor | value_changed | |
| exposedField | SFVec2f | translation | |
| exposedField | SFBool | linked | FALSE |

}

The two exposed fields, translation and linked, allow fewer data points to represent the animation path if the separate components of a value are linked, or follow the same animation path. For example, color is an RGB value and a color value is represented by three values, or components, corresponding to each of the three colors.

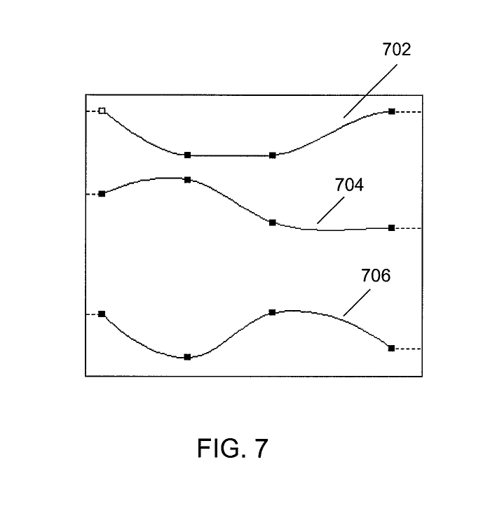

The animation path of each of the three color values, or components, may be independent, or linked together. FIG. 7 is a chart illustrating three independent components of a color. In FIG. 7, the three curves 702, 704, and 706 correspond to the three components, for example, the three color values red, green and blue of an object's color in a scene. As shown in FIG. 7, the three curves, or components, are independent, changing values unrelated to the other components. In this situation the exposed field “linked” is set to false, corresponding to components that are not “linked” to each other. If the components are not linked then the number of key and key_value used are:

m curves are specified, one for each of the m components;

n curve sections are identified for each curve;

there are n+1 keys corresponding to the n curve sections; and

the number of key_value is m(3n+1) corresponding to (3n+1 control points per curve).

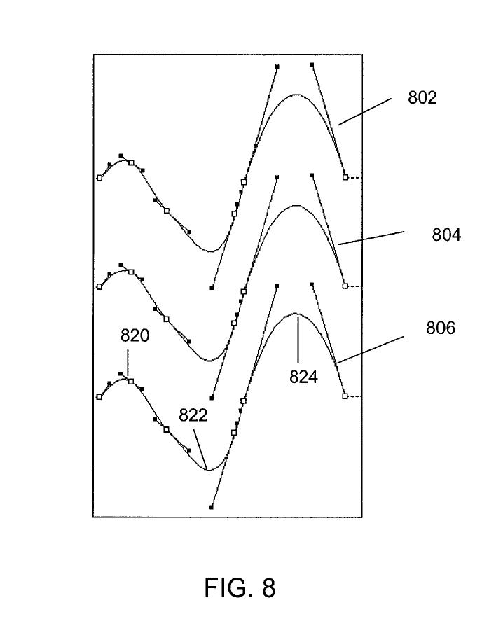

If the animation path of each of the three color components are linked, following the same animation path with only a translation difference for each component. FIG. 8 is a chart illustrating three independent color components. In FIG. 8, the three curves 802, 804, and 806 correspond to the three color components, for example, the values corresponding to the three colors red, green and blue of an object in a scene. As shown in FIG. 8, the three curves, or components, are linked, with each value following the same animation path except for a translation value. In this situation the exposed field “linked” is set to true, corresponding to color components being “linked” to each other. If the color components are linked then the number of key and key_value used are:

one curve is specified for all of the m components;

n curve sections are identified for the curve;

there are n+1 keys corresponding to the n curve sections;

the number of key Value is (3.n+1) control points; and

the exposed field “translation” contains the translation factor from the first component to the remaining components

PositionCurveInterpolator

The PositionCurveInterpolator type of non-linear interpolator may be used, for example, to animate objects by moving the object along an animation path specified by key_value corresponding to control points that define a non-linear movement. The syntax for the PositionCurveInterpolator is:

PositionCurveInterpolator {

| | | | |
|---|---|---|---|
| eventIn | SFFloat | set_fraction | |
| exposedField | MFFloat | key | |
| exposedField | MFVec3f | keyValue | |
| eventOut | SFVec3f | value_changed | |
| exposedField | SFVec2f | translation | |
| exposedField | SFBool | linked | FALSE |

}

The PositionCurveInterpolator outputs a 3D coordinate value. As discussed above, in relation to the ColorCurveInterpolator, the PositionCurveInterpolator supports linked, or independent, components of the 3D coordinate value.

Position2DCurveInterpolator

The Position2DCurveInterpolator may be used, for example, to animate objects in two dimensions along an animation path specified by key_value corresponding to control points that define a non-linear movement. The syntax for the Position2DCurveInterpolator is:

| Position2DCurveInterpolator { | | | |
|---|---|---|---|
| eventIn | SFFloat | set_fraction | |
| exposedField | MFFloat | key | |
| exposedField | MFVec2f | keyValue | |
| eventOut | SFVec2f | value_changed | |
| exposedField | SFFloat | translation | |
| exposedField | SFBool | linked | FALSE |

}

The Positon2DCurveInterpolator outputs a 2D coordinate value. As discussed above, in relation to the ColorCurveInterpolator, the PositionCurveInterpolator supports linked, or independent, components of the 2D coordinate value.

Example key and key_value of a CurveInterpolator

Following is an example of key and key_value data for a CurveInterpolator node. The following key and key_value represent the linked curves illustrated in FIG. 8.

CurveInterpolator {

key [ 0 0.20 0.75 1]
keyValue [

0 0 0, 14 −0.8 6.5, 24.2 −2 11, 31.2 −4.5 12.6,
12.898 −41.733 −25.76, 50.8 −11 17.8, 21.5 −58.8 −34.7,
9 −33.9 −21.8, 4.7 −19.9 −13, 0 0 0

]

}

The linked animation path shown in FIG. 8 is divided into three (3) sections 820, 822, and 824. Thus there are four (4) keys corresponding to (the number of sections+1). There are ten (10) key_value corresponding to ((three * the number of sections)+1)).

Deformation of a Scene

Another tool used in animation are deformations of a scene. Examples of deformations include space-wraps and free-form deformations (FFD). Space-warps deformations are modeling tools that act locally on an object, or a set of objects. A commonly used space-wrap is the Free-Form Deformation tool. Free form deformation is described in Extended Free-Form Deformation: a sculpturing tool for 3D geometric modeling, by Coquillard and Sabine, INRIA, RR-1250, June 1990, which is incorporated herein in its entirety. The FFD tool encloses a set of 3D points, not necessarily belonging to a single surface, by a simple mesh of control points. Movement of the control points of this mesh, results in corresponding movement of the points enclosed within the mesh.

Use of FFD allows for complex local deformations while only needing to specify a few parameters. This is contrasted with MPEG-4 animation tools, for example, BIFS-Anim, CoordinateInterpolator and NormalInterpolator, which need to specify at each key frame all the points of a mesh, even those not modified.

A CoordinateDeformer node has been proposed by Blaxxun Interactive as part of their nonuniform rational B-spline (NURBS) proposal for VRML97, Blaxxun Interactive. NURBS extension for VRML97, April 1999 which is incorporated herein in its entirety. The proposal can be found at Blaxxun Interactive, Inc. web site at the “World Wide Web” URL www.blaxxun.com/developer/contact/3d/nurbs/overview.htlm. The CoordinateDeformation node proposed by blaxxun is quite general. In accordance with the invention usage of the node may be simplified. An aspect of the simplified node is to deform a sub-space in the 2D/3D scene. Consequently, there is no need to specify input and output coordinates or input transforms. The sub-scene is specified in children field of the node using the DEF/USE mechanism of VRML. In addition, this construction enables nested free-form deformations. The syntax of FFD and FFD2D nodes are:

FFD {

| | | | |
|---|---|---|---|
| eventIn | MFNode | addChildren | |
| eventIn | MFNode | removeChildren | |
| exposedField | MFNode | children | [] |
| field | SFInt32 | uDimension | 0 |
| field | SFInt32 | vDimension | 0 |
| field | SFInt32 | wDimension | 0 |
| field | MFFloat | uKnot | [] |
| field | MFFloat | vKnot | [] |
| field | MFFloat | wKnot | [] |
| field | SFInt32 | uOrder | 2 |
| field | SFInt32 | vOrder | 2 |
| field | SFInt32 | wOrder | 2 |
| exposedField | MFVec3f | controlPoint | [] |
| exposedField | MFFloat | weight | [] |

}
FFD2D {

| | | | |
|---|---|---|---|
| eventIn | MFNode | addChildren | |
| eventIn | MFNode | removeChildren | |
| exposedField | MFNode | children | [] |
| field | SFInt32 | uDimension | 0 |
| field | SFInt32 | vDimension | 0 |
| field | MFFloat | uKnot | [] |
| field | MFFloat | vKnot | [] |
| field | SFInt32 | uOrder | 2 |
| field | SFInt32 | vOrder | 2 |
| exposedField | MFVec2f | controlPoint | [] |
| exposedField | MFFloat | weight | [] |

}

The FFD node affects a scene only on the same level in the scene graph transform hierarchy. This apparent restriction is because a FFD applies only on vertices of shapes. If an object is made of many shapes, there may be nested Transform nodes. If only the DEF of a node is sent, then there is no notion of what the transforms applied to the nodes are. By passing the DEF of a grouping node, which encapsulates the scene to be deformed, allows for effectively calculating the transformation applied on a node.

Even if this node is rather CPU intensive, it is very useful in modeling to create animations involving deformations of multiple nodes/shapes. Because very few control points need to be moved, an animation stream would require fewer bits. A result of using the node requires that that the client terminal have the processing power to compute the animation.

Following is an example of an FFD node:

# The control points of a FFD are animated. The FFD encloses two shapes which are
# deformed as the control points move.

DEF TS TimeSensor {}
DEF PI PositionInterpolator {

key [ ... ]
keyValue [ ... ]

}
DEF BoxGroup Group {

children [ Shape { geometry Box {} } ]

}
DEF SkeletonGroup Group {

children [

...# describe here a full skeleton

]

}
DEF FFDNode FED {

...# specify NURBS deformation surface
children [

USE BoxGroup
USE SkeletonGroup

]

}
ROUTE TS.fraction_changed TO PI.set_fraction
ROUTE PI.value_changed TO FFDNode.controlPoint

Textual Framework for Animation

In many systems animation is sent from a server to a client, or streamed. Typically, the animation is formatted to minimize the bandwidth required for sending the animation. For example, in MPEG-4, a Binary Format for Scenes (BIFS) is used. In particular, BIFS-Anim is a binary format used in MPEG-4 to transmit animation of objects in a scene. In BIFS-Anim each animated node is referred to by its DEF identifier and one, or many, of its fields may be animated. BIFS-Anim utilizes a key frame technique that specifies the value of each animated field frame by frame, at a defined frame rate. For better compression, each field value is quantized and adaptively arithmetic encoded.

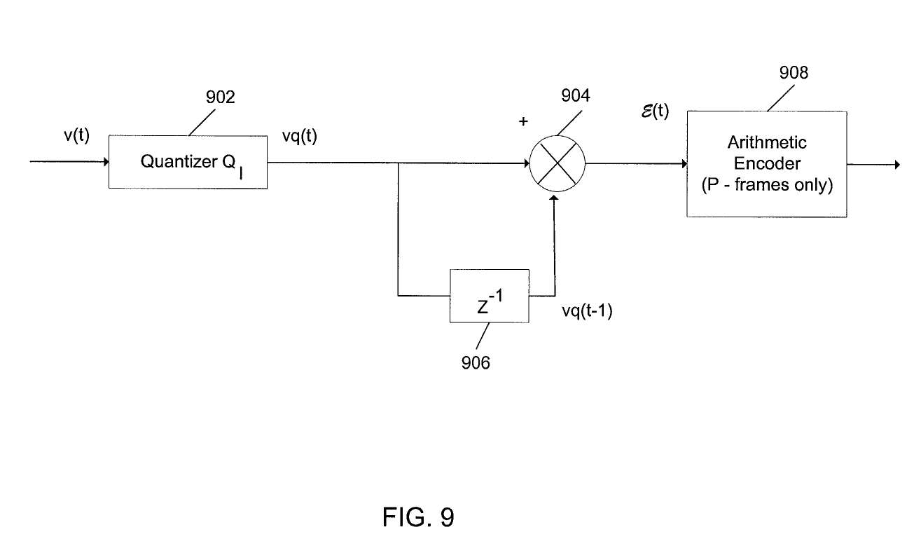

There are two kinds of frames are available: Intra; and Predictive. FIG. 9 is a block diagram of the BIFS-Anim encoding process. In an animation frame, at time t, a value of a field of one of an animation nodes v(t) is quantized. The value of the field is quantized using the field's animation quantizer Q_{I} 902. The subscript I denotes that parameters of the Intra frame are used to quantize a value v(t) to a value vq(t). The output of the quantizer Q_{I} 902 is coupled to a mixer 904 and a delay 906. The delay 906 accepts the output of the quantizer Q_{I} 902 and delays it for one frame period. The output of the delay 906 is then connected to a second input to the mixer 904.

The mixer 904 has two inputs that accept the output of the quantizer Q_{I} 902 and the output of the delay 906. The mixer 904 outputs the difference between the two signals present at its input represented by ε(t)=vq(t)−vq(t−1). In an Intra frame, the mixer 904 output is vq(t) because there is no previous value vq(t−1). The output of the mixer 904 is coupled to an arithmetic encoder 908. The arithmetic encoder 908 performs a variable length coding of ε(t). Adaptive Arithmetic encoding is a well-known technique described in Arithmetic Coding for Data Compression, by I. H. Witten, R. Neal, and J. G. Cleary, Communications of the ACM, 30:520-540, June 1997, incorporated in its entirety herein.

As discussed above, I-frames contain raw quantized field values vq(t), and P-frames contain arithmetically encoded difference field values ε(t)=vq(t)−vq(t−1). As BIFS-Anim is a key-frame based system, a frame can be only I or P, consequently all field values must be I or P coded, and each field is animated at the same frame rate. This contrast with track-based systems where each track is separate from the others and can have a different frame rate.

The BIFS' AnimationStream node has an url field. The url field may be associated with a file with an extension of “anim”. The anim file uses the following nodes:

Animation {

| | | | | |
|---|---|---|---|---|
| field | SFFloat | rate | | 30 |
| field | MFAnimationNode | children | | [] |
| field | SFConstraintNodeconstraint | NULL | | |
| field | MFInt32 | policy | NULL | |

}

In the anim file “rate” is expressed in frames per second. A default value for “rate” is 30 frames per second (fps). Children nodes of the animation node includes:

AnimationNode {

| | | | |
|---|---|---|---|
| field | SFInt32 | nodeID | |
| field | MFAnimationField | fields | [] |

}
AnimationField {

| | | | |
|---|---|---|---|
| field | SFString | name | |
| field | SFTime | startTime | |
| field | SFTime | stopTime | |
| field | SFNode | curve | |
| field | SFNode | velocity | |
| field | SFConstraintNodeconstraint | NULL | |
| field | SFFloat | rate | 30 |

}

In the AnimationNode “nodeID” is the ID of the animated node. And “fields” are the animated fields of the node.

In the AnimationField “name” is the name of the animated field; “curve” is an interpolator, for example, a CurveInterpolator node; “startTime” and “stopTime” are used to determine when the animation starts and ends. If startTime=−1, then the animation should start immediately. The “rate” is not used for BIFS-Anim but on a track-based system it could be used to specify an animation at a specific frame rate for this field. A default value of 0 is used to indicate the frame rate is the same as the Animation node.

The syntax described above is sufficient for an encoder to determine when to send the values of each field. And, in addition, when to send I and P frames, with respect to the following constraints:

Constraint {

| | | | |
|---|---|---|---|
| field | SFInt32 | rate | |
| field | SFInt32 | norm | |
| field | SFFloat | error | 0 |

}

In the above constraints, “rate” is the maximal number of bits for this track; “norm” is the norm used to calculate the error between real field values and quantized ones.

An error is calculated for each field over its animation time. If norm=0, then it is possible to use a user-defined type of measure. A user may also specify global constraints for the whole animation stream. By default “constraint” is NULL, which means an optimized encoder may use rate-distortion theory to minimize the rate and distortion over each field, leading to an optimal animation stream. By default, error=0, which means the bit budget is specified and the encoder should minimize the distortion for this budget. If rate=0 and error>0, the maximal distortion is specified and the encoder should minimize the bit rate. Table 1 summarizes the error measure.

TABLE 1
Animation Error Measure.

| | Error measure |
|---|---|
| 0 | User defined |
| 1 | Absolute: ε = \|v − vq\| |
| 2 | Least- |
| | square: ε = (v−vq)² |
| 3 | Max: ε = max \|v− vq\| |

The “policy” field indicates how I and P-frames are stored in the animation stream. For example, if policy=0, then frame storage is determined by the encoder. If policy=1T, then frames are stored periodically with an I frame stored every T frames. If policy=2T₀ . . . Tₙ, then I frames are stored at times specified by the user. Table 2 summarized the frame storage policy.

TABLE 2
Frame Storage Policy

| IP Policy | Frame Storage |
|---|---|
| 0 | Up to the encoder |
| 1 T | Periodic: every T frames, an I-frame is stored |
| 2 T₀ . . . Tₙ | User defined: I-frames are stored at specified frames. |

By default, if policy is not specified, it is similar to policy 0, i.e., frame storage is determined by the encoder.

As discussed above, in BIFS-Anim when an animation curve of a field starts, an Intra frame need to be sent for all fields. This is a drawback of a key-frame based system. In some situation, it may be that I-frame is sent between two I-frames specified by the IP policy. This would increase the bit rate.

Because we are using VRML syntax, these nodes can be reused using the DEF/USE mechanism.

In addition, it would be beneficial to have a curve and re-use it with different velocity curves. Curves with different velocity may be used to produce, for example, ease-in and ease-out effects, or travel at intervals of constant arclength. This reparametrization is indicated by “velocity”, which specifies another curve (through any interpolators). If “velocity” is specified, the resulting animation path is obtained by:

C(u)=curve(u)o velocity(u)

This is equivalent to use a ScalarInterpolator for the velocity, with its value_changed router to the set_fraction field of an interpolator for curve. This technique can also be used to specify different parameterizations at the same time. For example, a PositionInterpolator could be used for velocity, giving three(3) linear parameterizations for each component of a PositionCurveInterpolator for curve. The velocity curve can also be used to move along the curve backwards. In addition, if the curves are linked, “velocity” can be used to specify different parameterization for each component.

System Block Diagram

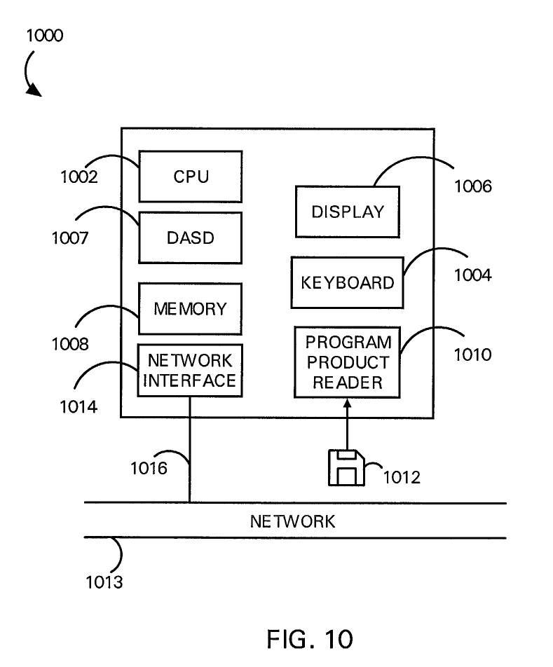

FIG. 10 is a block diagram of an exemplary computer 1000 such as might be used to implement the CurveInterpolator and BIFS-Anim encoding described above. The computer 1000 operates under control of a central processor unit (CPU) 1002, such as a “Pentium” microprocessor and associated integrated circuit chips, available from Intel Corporation of Santa Clara, Calif., USA. A computer user can input commands and data, such as the acceptable distortion level, from a keyboard 1004 and can view inputs and computer output, such as multimedia and 3D computer graphics, at a display 1006. The display is typically a video monitor or flat panel display. The computer 1000 also includes a direct access storage device (DASD) 1007, such as a hard disk drive. The memory 1008 typically comprises volatile semiconductor random access memory (RAM) and may include read-only memory (ROM). The computer preferably includes a program product reader 1010 that accepts a program product storage device 1012, from which the program product reader can read data (and to which it can optionally write data). The program product reader can comprise, for example, a disk drive, and the program product storage device can comprise removable storage media such as a magnetic floppy disk, a CD-R disc, or a CD-RW disc. The computer 1000 may communicate with other computers over the network 1013 through a network interface 1014 that enables communication over a connection 1016 between the network and the computer.

The CPU 1002 operates under control of programming steps that are temporarily stored in the memory 1008 of the computer 1000. The programming steps may include a software program, such as a program that performs non-linear interpolation, or converts an animation file into BIFS-Anim format. Alternatively, the software program may include an applet or a Web browser plug-in. The programming steps can be received from ROM, the DASD 1007, through the program product storage device 1012, or through the network connection 1016. The storage drive 1010 can receive a program product 1012, read programming steps recorded thereon, and transfer the programming steps into the memory 1008 for execution by the CPU 1002. As noted above, the program product storage device can comprise any one of multiple removable media having recorded computer-readable instructions, including magnetic floppy disks and CD-ROM storage discs. Other suitable program product storage devices can include magnetic tape and semiconductor memory chips. In this way, the processing steps necessary for operation in accordance with the invention can be embodied on a program product.

Alternatively, the program steps can be received into the operating memory 1008 over the network 1013. In the network method, the computer receives data including program steps into the memory 1008 through the network interface 1014 after network communication has been established over the network connection 1016 by well-known methods that will be understood by those skilled in the art without further explanation. The program steps are then executed by the CPU.

The foregoing description details certain embodiments of the invention. It will be appreciated, however, that no matter how detailed the foregoing appears, the invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

We claim:

1. A method of specifying an animation path in a virtual reality scene descriptive language, the method comprising:
segmenting the animation path in a scene description into at least one section;
determining a non-linear parametric representation that represents each section; and
representing the non-linear parametric representation in the virtual reality scene descriptive language.

2. A method as defined in claim 1, wherein the non-linear parametric representation comprises a combination of one or more predetermined curves.

3. A method as defined in claim 2, wherein the one or more curves are Bezier curves.

4. A method as defined in claim 3, wherein each Bezier curve is a cubic function.

5. A method as defined in claim 1, wherein the animation path is a scalar value.

6. A method as defined in claim 1, wherein the animation path is a color representation.

7. A method as defined in claim 1, wherein the animation path is a three dimensional position representation.

8. A method as defined in claim 1, wherein the animation path is a two dimensional position representation.

9. A method as defined in claim 1, wherein the non-linear parametric representation in the virtual reality scene descriptive language is transmitted to a remote unit where it is used to reconstruct the animation path.

10. A method of processing a scene in a virtual reality scene descriptive language, the method comprising:
receiving an initial scene representation in a virtual reality scene descriptive language;
specifying changes in the scene representation from the initial value; and
producing interpolated scenes between the initial value and the changes from the initial value by a non-linear interpolator process.

11. A method as defined in claim 10, wherein the changes in the scene representation are specified by a set of control points.

12. A method as defined in claim 10, wherein the non-linear interpolation comprises a combination of one or more curves.

13. A method as defined in claim 12, wherein the one or more curves are Bezier curves.

14. A method as defined in claim 13, wherein the Bezier curve is a cubic.

15. A method as defined in claim 10, wherein the interpolation is of a scalar value.

16. A method as defined in claim 10, wherein the interpolation is of a color representation.

17. A method as defined in claim 10, wherein the interpolation is of a three dimensional position representation.

18. A method as defined in claim 10, wherein the interpolation is of a two dimensional position representation.

19. A method as defined in claim 10, wherein the specified changes in the scene representation from the initial value are received from a remote server

20. A decoder used in a VRML scene description for processing an animation, the decoder comprising:
an interpolator configured to receive control parameters relating to an animation path in a scene description and a timing signal input; and
an interpolation engine configured to accept the control parameters and the timing signal from the interpolator node and reproduce a non-linear animation path, and to output a new animation value to the interpolator node for use in the scene description.

21. A decoder as defined in claim 20, wherein the interpolator engine comprises a combination of one or more curves.

22. A decoder as defined in claim 21, wherein the one or more curves are Bezier curves.

23. A decoder as defined in claim 22, wherein each Bezier curve is a cubic function.

24. A method of deforming a scene, the method comprising:
defining a sub-scene, of the scene, in a child node of a scene descriptive language;
moving control points in the sub-scene to a desired location; and
deforming the sub-scene in accordance with the movement of the control points.
